(19) United States
(12) Patent Application Publication
(10) Pub. No.: US 2026/0038307 A1
(43) Pub. Date: Feb. 5, 2026

(54) CONTROL APPARATUS, CONTROL METHOD, AND NON-TRANSITORY COMPUTER READABLE MEDIUM

(71) Applicant: NEC Corporation, Tokyo (JP)

(72) Inventor: Toru AOYAGI, Tokyo (JP)

(73) Assignee: NEC Corporation, Tokyo (JP)

(21) Appl. No.: 19/352,640

(22) Filed: Oct. 8, 2025

Related U.S. Application Data
(63) Continuation of application No. 17/783,760.

(30) Foreign Application Priority Data
Dec. 20, 2019 (JP) 2019-230599

(51) Int. Cl. G06V 40/60; G06F 21/32; G06F 21/33; G06V 10/74; G06V 40/16

(52) U.S. Cl. CPC G06V 40/60; G06F 21/32; G06F 21/33; G06V 10/74; G06V 40/172

(57) ABSTRACT

A control apparatus (2000) acquires a certificate image (30) being an image of an identification card. The control apparatus (2000) outputs screen data (70) of a screen (60) including the certificate image (30). The control apparatus (2000) acquires a user image (50) generated by capturing an image performed in a state where the screen (60) is displayed.

This application is a continuation application of U.S. patent application Ser. No. 17/783,760 filed on Jun. 9, 2022, which is a National Stage Entry of PCT/JP2020/047162 filed on Dec. 17, 2020, which claims priority from Japanese Patent Application 2019-230599 filed on Dec. 20, 2019, the contents of all of which are incorporated herein by reference, in their entirety.

### TECHNICAL FIELD

The present invention relates to personal identification using an identification card.

### BACKGROUND ART

When opening a bank account, creating a credit card, or the like, personal identification using an identification card is performed. Then, as in a case of opening an account or the like via the Internet, and the like, an image acquired by capturing an identification card by a camera, instead of an original of the identification card, may be used for personal identification.

There is Patent Document 1 as a related document relating to personal identification using an image of an identification card. Patent Document 1 discloses a system for confirming that a personal identification document is of a user by comparing capturing data about a face photograph of the personal identification document with capturing data about the user.

In addition, in the system according to Patent Document 1, in order to acquire an image of a plurality of surfaces of a personal identification document (identification card), a moving image capturing the personal identification document is generated, while issuing an instruction such as “please capture a front surface of a personal identification document” or “please capture a back surface of a personal identification document” on a user terminal. Then, the moving image is transmitted to an authentication server.

### Related Document

### Patent Document

[Patent Document 1] Japanese Patent No. 6541140

### DISCLOSURE OF THE INVENTION

### Technical Problem

The inventor of the present invention has developed a new technique for performing personal identification by using an image of an identification card and an image of a user. One of objects of the present invention is to provide a new technique for performing personal identification by using an image of an identification card and an image of a user.

### Solution to Problem

A control apparatus according to the present invention includes 1) a first acquisition unit that acquires a certificate image being an image of an identification card, 2) a screen data output unit that outputs screen data of a first screen including the certificate image, and 3) a second acquisition unit that acquires an image of a user being generated by capturing an image performed in a state where the first screen is displayed.

A control method according to the present invention is executed by a computer. The control method includes 1) a first acquisition step of acquiring a certificate image being an image of an identification card, 2) a screen data output step of outputting screen data of a first screen including the certificate image, and 3) a second acquisition step of acquiring an image of a user being generated by capturing an image performed in a state where the first screen is displayed.

### Advantageous Effects of Invention

According to the present invention, a new technique for performing personal identification by using an image of an identification card and an image of a user is provided.

### BRIEF DESCRIPTION OF THE DRAWINGS

FIG. 1 is a diagram for describing an outline of a control apparatus according to an example embodiment 1.

FIG. 2 is a diagram illustrating a functional configuration of the control apparatus according to the example embodiment 1.

FIG. 3 is a diagram illustrating a computer for achieving the control apparatus.

FIG. 4 is a flowchart illustrating a flow of processing executed by the control apparatus according to the example embodiment 1.

FIG. 5 is a diagram illustrating a usage environment of the control apparatus.

FIG. 6 is a flowchart illustrating a flow of personal identification of a user.

FIG. 7 is a diagram illustrating a screen displayed on a display apparatus by an application when causing a user to capture an image of an identification card.

FIG. 8 is a diagram illustrating a screen for capturing an image of a user's face.

FIG. 9 is a diagram illustrating a screen for performing biometric detection for a user.

FIG. 10 is a diagram illustrating a screen for performing confirmation of a thickness of an identification card.

### DESCRIPTION OF EMBODIMENTS

Hereinafter, an example embodiment of the present invention will be described with reference to the drawings. Note that, in all the drawings, a similar component is denoted by a similar reference sign, and description thereof is not repeated as appropriate. In addition, except for a case described in particular, in each block diagram, each block represents a configuration of a functional unit, not a configuration of a hardware unit. In the following description, various predetermined values (threshold values or the like) are stored in advance in a storage apparatus being accessible from a functional component unit that uses the values, unless otherwise described.

### Example Embodiment 1

### <Overview>

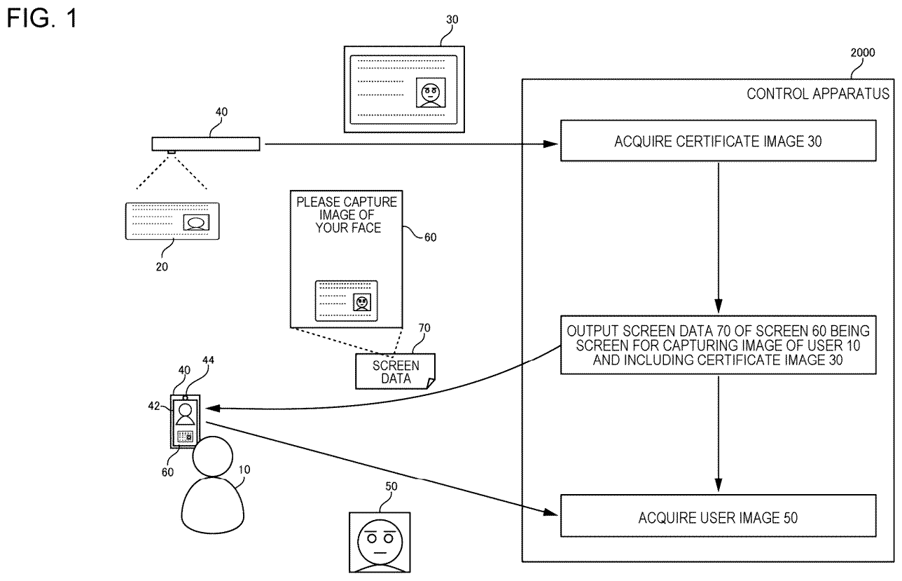

FIG. 1 is a diagram for describing an outline of a control apparatus 2000 according to the present example embodiment. Note that, FIG. 1 is an example for facilitating understanding of the control apparatus 2000, and a function of the control apparatus 2000 is not limited to that illustrated in FIG. 1.

The control apparatus 2000 acquires data used for personal identification of a user 10. Specifically, the control apparatus 2000 acquires a user image 50 and a certificate image 30. The user image 50 is an image generated by capturing an image of the user 10. The certificate image 30 is an image generated by capturing an image of a face of an identification card 20. The identification card 20 is any certificate that can be used for certificating a person's identity. For example, the identification card 20 is a driver's license, another license, a national identification number card, a passport, various certificates, a student's certificate, a company's identification card, an insurance card, or the like. However, it is preferable that a face image of a certified person (a person whose identity is certified by the identification card 20) is displayed on the face of the identification card 20. Note that, in the following description, a surface on which a face image of a certified person is displayed between faces of the identification card 20 is referred to as a main surface. In addition, the other surface is referred to as a back surface.

The control apparatus 2000 acquires the certificate image 30 prior to the user image 50. The certificate image 30 is generated, for example, by a camera 44 controllable by a terminal (user terminal 40) used by a user. The camera 44 may be incorporated in the user terminal 40, or may be externally attached to the user terminal 40. Note that, the control apparatus 2000 may be achieved as the user terminal 40, or may be achieved as another apparatus (e.g., a server machine) that acquires data from the user terminal 40. In the example in FIG. 1, the control apparatus 2000 is achieved as an apparatus being separate from the user terminal 40.

After acquiring the certificate image 30, the control apparatus 2000 outputs a screen data 70 of a screen 60 on which an image of the user 10 is to be captured. The screen data 70 may be the screen 60 itself, or may be data for generating the screen 60.

The screen 60 includes the certificate image 30. The screen 60 is displayed on a display apparatus 42 controllable by the user terminal 40. Note that, the display apparatus 42 may be incorporated in the user terminal 40, or may be externally attached to the user terminal 40.

In a state where the screen 60 is displayed on the display apparatus 42, the user 10 captures an image of the user 10 by using the camera 44 provided in the user terminal 40. Thus, the user image 50 is generated by the camera 44. The user image 50 preferably includes at least a face of the user 10. The control apparatus 2000 acquires the user image 50 generated by the camera 44.

### One Example of Advantageous Effect

According to the control apparatus 2000 of the present example embodiment, when causing the user 10 to capturing an image of himself/herself for personal identification, the certificate image 30 being an image of a face of the identification card 20 is displayed on the display apparatus 42 of the user terminal 40 used by the user 10. According to such a display, the user 10 captures his/her own image while viewing the image of the identification card 20 which has been declared to be his/her own. Therefore, when the user 10 is trying to illegally use the identification card 20 of another person, the user 10 has to capture his/her own image while viewing the image of the identification card 20 of the another person, and it is conceivable that the user 10 feels psychological resistance. Therefore, according to the control apparatus 2000 of the present example embodiment, it is possible to reduce possibility that a user illegally uses the identification card 20.

Hereinafter, the present example embodiment will be described in further detail.

### Example of Functional Configuration

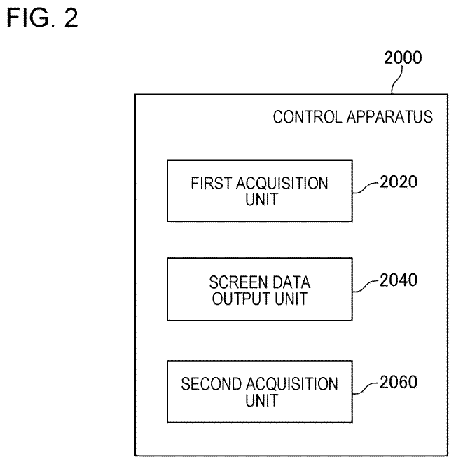

FIG. 2 is a diagram illustrating a functional configuration of the control apparatus 2000 according to the example embodiment 1. The control apparatus 2000 includes a first acquisition unit 2020, a screen data output unit 2040, and a second acquisition unit 2060. The first acquisition unit 2020 acquires the certificate image 30. The screen data output unit 2040 outputs the screen data 70 representing the screen 60. The second acquisition unit 2060 acquires the user image 50. Generation of the user image 50 (capturing an image of the user 10) is performed in a state where the screen 60 is displayed on the display apparatus 42.

### Example of Hardware Configuration of Control Apparatus 2000

Each functional component unit of the control apparatus 2000 may be achieved by hardware (e.g., a hard-wired electronic circuit, or the like) that achieves each functional component unit, or may be achieved by a combination of hardware and software (e.g., a combination of an electronic circuit and a program that controls the electronic circuit, or the like). Hereinafter, a case where each functional component unit of the control apparatus 2000 is achieved by a combination of hardware and software will be further described.

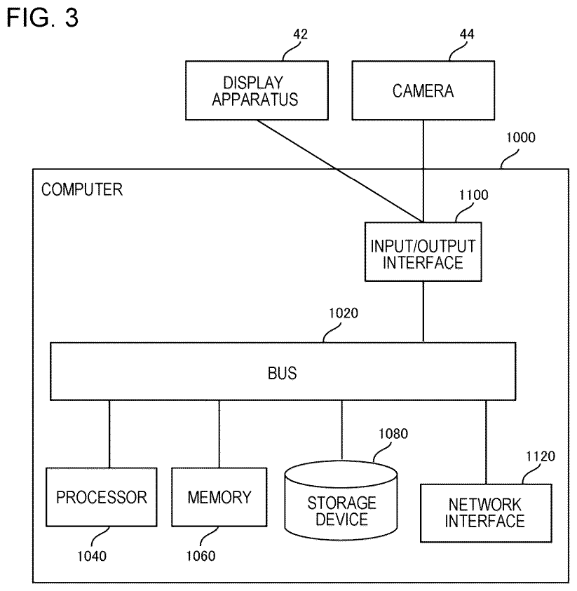

FIG. 3 is a diagram illustrating a computer 1000 for achieving the control apparatus 2000. The computer 1000 is any computer. For example, the computer 1000 is a portable computer such as a smartphone or a tablet terminal. In addition, for example, the computer 1000 may be a stationary computer such as a personal computer (PC) or a server machine.

The computer 1000 may be a dedicated computer designed to achieve the control apparatus 2000, or may be a general-purpose computer. In the latter case, for example, a function of the control apparatus 2000 is achieved in the computer 1000 by installing a predetermined application (an application 100 to be described later) with respect to the computer 1000. The application described above is configured by a program for achieving each functional component unit of the control apparatus 2000.

The computer 1000 includes a bus 1020, a processor 1040, a memory 1060, a storage device 1080, an input/output interface 1100, and a network interface 1120. The bus 1020 is a data transmission path through which the processor 1040, the memory 1060, the storage device 1080, the input/output interface 1100, and the network interface 1120 mutually transmit and receive data. However, a method of connecting the processors 1040 and the like to each other is not limited to bus connection.

The processor 1040 is various processors such as a central processing unit (CPU), a graphics processing unit (GPU), and a field-programmable gate array (FPGA). The memory 1060 is a main storage apparatus achieved by using a random access memory (RAM) or the like. The storage device 1080 is an auxiliary storage apparatus achieved by using a hard disk, a solid state drive (SSD), a memory card, a read only memory (ROM), or the like.

The input/output interface 1100 is an interface for connecting the computer 1000 and an input/output device. For example, an input apparatus such as a keyboard and an output apparatus such as a display apparatus are connected to the input/output interface 1100. When the control apparatus 2000 is achieved by the user terminal 40, the display apparatus 42 and the camera 44 are connected to the input/output interface 1100.

The network interface 1120 is an interface for connecting the computer 1000 to a communication network. The communication network is, for example, a local area network (LAN) or a wide area network (WAN).

The storage device 1080 stores a program module (program module for achieving the above-described application) for achieving each functional component unit of the control apparatus 2000. The processor 1040 achieves a function associated with each program module by reading each program module into the memory 1060 and executing the problem module.

### <Regarding User Terminal 40>

The user terminal 40 is any terminal operated by the user 10. When the control apparatus 2000 is achieved by an apparatus other than the user terminal 40, the user terminal 40 has the hardware configuration illustrated in FIG. 3, for example, similarly to the control apparatus 2000.

### <Flow of Processing>

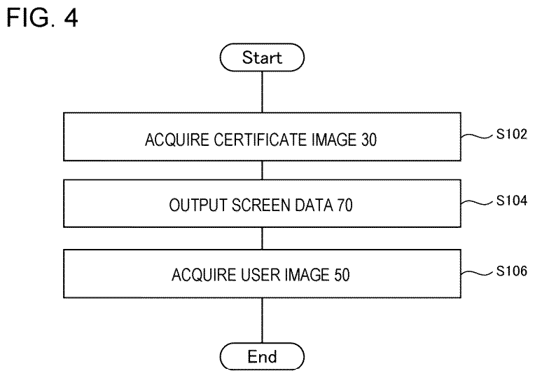

FIG. 4 is a flowchart illustrating a flow of processing executed by the control apparatus 2000 according to the example embodiment 1. The first acquisition unit 2020 acquires the certificate image 30 (S102). The screen data output unit 2040 outputs the screen data 70 (S104). The second acquisition unit 2060 acquires the user image 50 (S106).

### <Acquisition of Certificate Image 30: S102>

The first acquisition unit 2020 acquires the certificate image 30 (S102). A method of acquiring the certificate image 30 by the first acquisition unit 2020 is various methods. For example, the first acquisition unit 2020 receives the certificate image 30 transmitted from an apparatus generating the certificate image 30. In addition, for example, the first acquisition unit 2020 accesses an apparatus generating the certificate image 30, and acquires the certificate image 30 stored in the apparatus.

Note that, the certificate image 30 may be stored, by an apparatus generating the certificate image 30, in a storage apparatus provided outside the apparatus. In this case, the first acquisition unit 2020 accesses the storage apparatus, and acquires the certificate image 30.

### <Regarding Generation of Certificate Image 30>

The certificate image 30 is generated by capturing an image of a face of the identification card 20. When generating the certificate image 30, it is preferable to capture an image of the identification card 20 in a state where the main surface of the identification card 20 is viewed in plan. In other words, it is preferable that the certificate image 30 is an image including the identification card 20 whose main surface is viewed in plan. However, the certificate image 30 may include the main surface of the identification card 20, and is not limited to the one in which the main surface is viewed in plan.

The certificate image 30 is generated by any capturing apparatus capable of capturing an image of the identification card 20. For example, the certificate image 30 is generated by capturing an image of the identification card 20 with the camera 44 provided in the user terminal 40. In addition, for example, the certificate image 30 may be generated by scanning the identification card 20 with a scanner. Note that, the certificate image 30 does not necessarily have to be generated in a flow of a procedure for personal identification, and may be stored in advance in a storage apparatus. In this case, for example, the user 10 uses the user terminal 40 to select an image to be used as the certificate image 30 from images stored in advance in a storage apparatus, and thereby provides the certificate image 30 to the control apparatus 2000.

### <Output of Screen Data 70: S104>

The screen data output unit 2040 outputs the screen data 70 (S104). The screen data 70 are screen data representing the screen 60. The screen 60 is a screen for capturing an image of the user 10 (generating the user image 50). In addition, the screen 60 includes the certificate image 30. For example, the screen data output unit 2040 acquires template data of the screen data 70 prepared in advance and the certificate image 30 acquired by the first acquisition unit 2020. Then, the screen data output unit 2040 combines the certificate image 30 and the template data, and thereby generates the screen data 70. Note that, an existing technique can be used as a technique for generating screen data of a screen including an image acquired from the outside, by combining a template of screen data and the image.

The screen data output unit 2040 outputs the generated screen data 70, and thereby displays the screen 60 on the display apparatus 42. As described above, the screen data 70 may be the screen 60 itself, or may be data for generating the screen 60. The data for generating the screen 60 are, for example, a combination of a piece of data of each text or an image included in the screen 60 and a piece of format data (e.g., HTML file) representing an arrangement of the text or image. In the latter case, the screen 60 is generated by performing processing for generating the screen 60 (e.g., processing for rendering an HTML file) on the screen data 70.

When the control apparatus 2000 is achieved by the user terminal 40, the screen data output unit 2040 outputs the screen 60 to the display apparatus 42. Herein, when the screen data 70 are data for generating the screen 60, the screen data output unit 2040 generates the screen 60 from the screen data 70, and outputs the generated screen 60 to the display apparatus 42.

On the other hand, when the control apparatus 2000 is achieved by an apparatus other than the user terminal 40, the screen data output unit 2040 outputs the screen data 70 to the user terminal 40. The user terminal 40 receiving the screen data 70 outputs the screen 60 to the display apparatus 42. Herein, when the received screen data 70 are data for generating the screen 60, the user terminal 40 generates the screen 60 from the screen data 70, and outputs the generated screen 60 to the display apparatus 42.

### <Acquisition of User Image 50: S106>

The second acquisition unit 2060 acquires the user image 50. A method of acquiring the user image 50 by the second acquisition unit 2060 is various methods. For example, the second acquisition unit 2060 receives the user image 50 transmitted from the camera 44. In addition, for example, the second acquisition unit 2060 accesses the camera 44, and acquires the user image 50 stored in the camera 44. In addition, when the camera 44 stores the user image 50 in an external storage apparatus, the second acquisition unit 2060 acquires the user image 50 from the storage apparatus.

### Specific Example of Using Control Apparatus 2000

Hereinafter, a specific method of using the control apparatus 2000 will be exemplified. However, the method of using the control apparatus 2000 is not limited to that described herein.

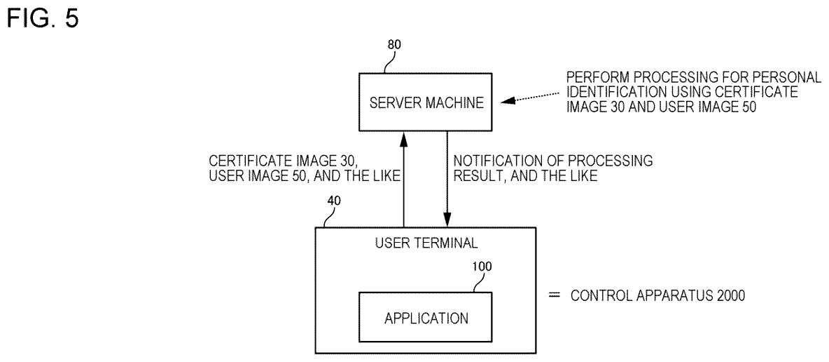

FIG. 5 is a diagram illustrating a usage environment of the control apparatus 2000. In this example, the control apparatus 2000 is achieved by the user terminal 40. The user terminal 40 is, for example, a smart phone provided with the camera 44.

The user 10 uses the user terminal 40, and thereby performs a procedure in which personal identification is required (e.g., opening a bank account). To do so, the user 10 uses the user terminal 40, and thereby provides a server machine 80 with various data necessary for personal identification.

An application 100 for causing the user terminal 40 to function as the control apparatus 2000 is installed in the user terminal 40. The user 10 starts the application 100 to perform a procedure. As described below, the application 100 controls a procedure performed by the user 10 by changing a screen displayed on the display apparatus 42 in response to a user input and a processing result in the server machine 80.

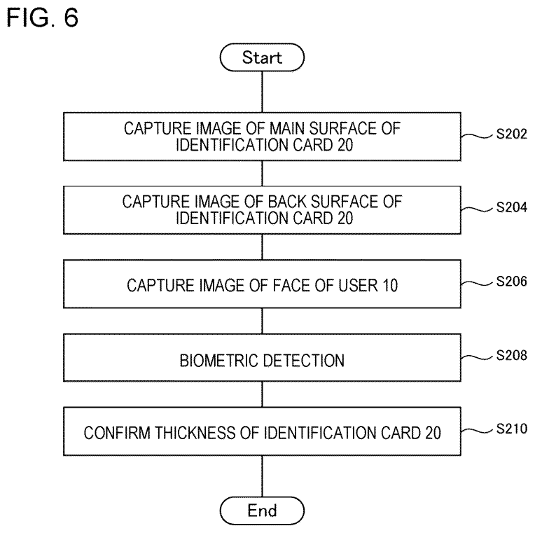

FIG. 6 is a flowchart illustrating a flow of personal identification of the user 10. The personal identification of the user 10 is performed in a flow of capturing an image of a main surface of the identification card 20 (S202), capturing an image of a back surface of the identification card 20 (S204), capturing an image of a face of the user 10 (S206), biometric detection (S208), and confirming a thickness of the identification card 20 (S210). Hereinafter, each will be described.

### <<Capturing an Image of the Identification Card 20: S202, S204>>

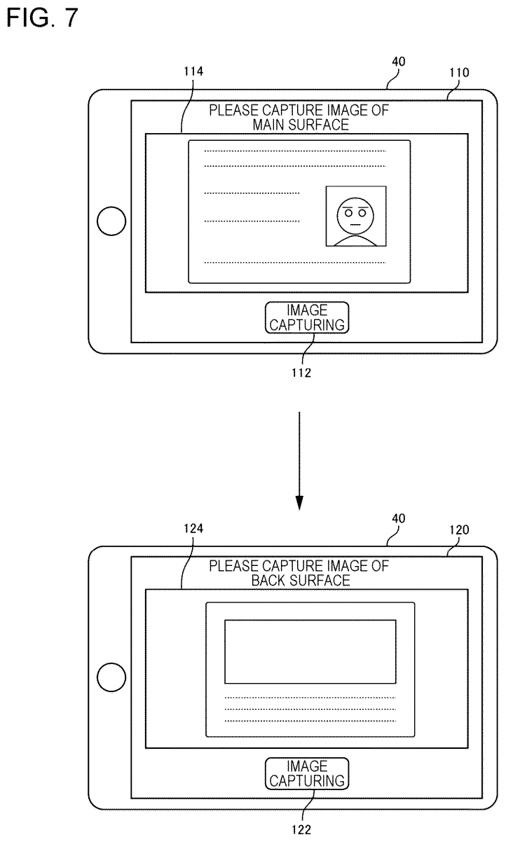

FIG. 7 is a diagram illustrating a screen displayed on the display apparatus 42 by the application 100 when the user 10 captures an image of the identification card 20. A screen 110 is a screen for capturing an image of the main surface of the identification card 20. A screen 120 is a screen for capturing an image of the back surface of the identification card 20.

An image generated by the camera 44 is displayed in real time in a display area 114 of the screen 110. The user 10 views the screen 110, confirms that an image of the main surface of the identification card 20 is correctly captured, and presses an image capturing button 112. As a result, an image generated by the camera 44 at a timing when the image capturing button 112 is pressed is stored in a storage apparatus of the user terminal 40 as an image (i.e., the certificate image 30) of the main surface of the identification card 20.

Note that, an image of the main surface of the identification card 20 may be automatically captured without providing the image capturing button 112 on the screen 110. For example, the camera 44 repeatedly captures an image from the time when the screen 110 is displayed, and generates a plurality of images. The application 100 determines a degree of image quality of each of the generated images, and when an image whose image quality is equal to or higher than a threshold value is detected, the application 100 stores the image in the storage apparatus of the user terminal 40 as an image of the main surface of the identification card 20.

As an index indicating a degree of image quality, reducing of defocusing and blurring, or the like can be used. Note that, an existing technique can be used as a technique for determining a degree of image quality of an image, based on reducing of defocusing and blurring, or the like.

In addition, the application 100 may determine whether the entire identification card 20 is included in an image, in addition to a degree of image quality. In this case, when an image satisfying a condition that “image quality is equal to or higher than a threshold value, and the entire identification card 20 is included” is detected from an image generated by the camera 44, the application 100 stores the image in the storage apparatus of the user terminal 40 as an image of the main surface of the identification card 20.

An existing technique can be used as a technique for determining whether an image includes a predetermined object. For example, when an object having a shape similar to a predetermined shape of the identification card 20 is detected from an image, the application 100 determines that the entire identification card 20 is included in the image.

In addition, it is preferable that an image of the main surface of the identification card 20 includes the identification card 20 in a size equal to or larger than a certain size. Therefore, a condition such as “a ratio of an image area representing the identification card 20 to the entire image is equal to or larger than a threshold value” may be further added to a condition for handling an image as the image of the main surface of the identification card 20.

When capturing an image of the main surface of the identification card 20 is completed, the application 100 changes a screen displayed on the display apparatus 42 from the screen 110 to the screen 120. The user 10 captures an image of the back surface of the identification card 20 by similar operation to an operation on the screen 110. As a result, the image of the back surface of the identification card 20 is also stored in the storage apparatus of the user terminal 40. Herein, an image capturing button 122 may also not be provided on the screen 120, and an image of the back surface of the identification card 20 may be automatically captured. The specific method is similar to the above-described method in which an image of the main surface of the identification card 20 is automatically captured.

The application 100 transmits images of the main surface and the back surface of the identification card 20 stored in the storage apparatus to the server machine 80. The server machine 80 performs processing for extracting necessary information from the image of the main surface and the image of the back surface of the identification card 20. For example, the server machine 80 performs optical character recognition (OCR) processing on the image of the main surface of the identification card 20, and thereby extracts various pieces of character information (e.g., a name and an address of the user 10, identification information attached to the identification card 20, and the like). In addition, the server machine 80 extracts an image of a person (hereinafter, a person image) from the image of the main surface of the identification card 20. Similarly, the server machine 80 extracts various pieces of information from the image of the back surface of the identification card 20.

Each of pieces of processing described above may be performed by the application 100. In this case, the application 100 transmits each piece of information extracted from an image of the identification card 20 to the server machine 80 together with an image of the identification card 20 or instead of the image of the identification card 20.

In addition, the application 100 may check whether capturing an image of the identification card 20 has been correctly performed, by extracting the above-described information. At this time, when necessary information cannot be extracted from the image of the identification card 20, the application 100 may display the screen 110 or the screen 120 again on the display apparatus 42 together with a message instructing in such a way as to restart photographing, and cause the user 10 to capture an image of the identification card 20 again.

Alternatively, the application 100 may accept input of personal information such as a name or the like from the user 10 separately, and check whether the information input by the user 10 matches information acquired from an image of the identification card 20. The check may be performed by the application 100, or may be performed by the server machine 80. In addition, for example, the application 100 may display information such as a name extracted from the image of the identification card 20 on the display apparatus 42, and cause the user 10 to be able to correct an erroneous portion. The processing can be performed at any timing after an image of the identification card 20 is captured (e.g., after an image of the back surface of the identification card 20 is captured, after a thickness of the identification card 20 is confirmed, or the like).

Herein, capturing an image of the identification card 20 separately from the user 10 in this manner has an advantage that a labor of the user 10 can be reduced and an advantage that a high-quality image can be acquired. When the user 10 is caused to simultaneously capture an image of both the user 10 and the identification card 20, the user 10 has to adjust an angle and the like of the identification card 20 and the camera 44 in such a way that both the user 10 and the identification card 20 are correctly captured by the camera 44. Thus, a labor of the user 10 required for capturing an image increases. Also, capturing an image may not be successful, resulting in poor quality of one or both of the images of the user 10 and the identification card 20. Therefore, in the present usage example, the identification card 20 and the user 10 are captured separately.

### <<Capturing an Image of a User 10's Face: S206>>

After transmitting the information extracted from the identification card 20 to the server machine 80, the application 100 causes the user 10 to capture an image of his/her face (S206). To do so, the application 100 outputs the screen 60 to the display apparatus 42.

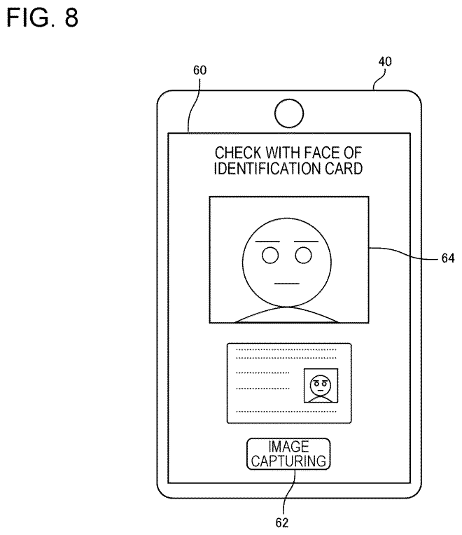

FIG. 8 is a diagram illustrating a screen for capturing an image of a user's face. As described above, the screen 60 includes the certificate image 30. In addition, in a display area 64 of the screen 60, similarly to the screen 110 and the like, an image generated by the camera 44 is displayed in real time. The user 10 views the display area 64, and presses an image capturing button 62 in such a way that his/her face is correctly captured. As a result, an image generated by the camera 44 at a timing when the image capturing button 62 is pressed is stored in the storage apparatus of the user terminal 40 as the user image 50.

The application 100 transmits the user image 50 to the server machine 80. The server machine 80 receiving the user image 50 compares a person image extracted from the certificate image 30 with the user image 50, and thereby determines whether the persons represented by these images are the same. This is equivalent to determining whether the identification card 20 included in the certificate image 30 is an identification card of the user 10. An existing technique can be used as a technique for determining whether a person represented by each of two images matches with each other.

When a person represented by the person image extracted from the certificate image 30 and a person represented by the user image 50 do not match, the server machine 80 transmits a notification indicating failure of matching to the application 100. The application 100 receiving the notification indicating failure of matching outputs a message indicating an error to the display apparatus 42.

When a person represented by the person image extracted from the certificate image 30 matches a person represented by the user image 50, the server machine 80 transmits a notification indicating success of matching to the application 100. The application 100 receiving the notification indicating success of matching outputs a screen for performing biometric detection to the display apparatus 42.

Including the certificate image 30 in the screen 60 in this manner has an advantageous effect, as described above, that the user 10 is psychologically less likely to illegally use of the identification card 20.

Herein, the image capturing button 62 may not be provided on the screen 60. In this case, while the screen 60 is displayed, the camera 44 repeatedly captures an image, and generates a plurality of user images 50. In addition, matching with a person image extracted from the certificate image 30 is performed for each of the plurality of user images 50 generated in this manner. Then, when any one of the user images 50 matches the person image extracted from the certificate image 30, it is handled as matching success. On the other hand, when there is no user image 50 that matches the person image extracted from the certificate image 30, it is handled as matching failure.

### <<Biometric Detection: S208>>

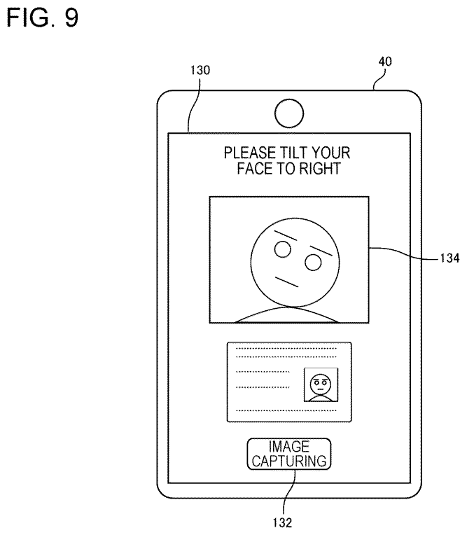

FIG. 9 is a diagram illustrating a screen for performing biometric detection for the user 10. The biometric detection herein is processing for confirming that an image captured by using the camera 44 is a person actually existing on the spot, and is not other than a person such as a photograph or the like. By performing biometric detection, it is possible to prevent the user 10 who is not a certified person of the identification card 20 from impersonating the certified person of the identification card 20 (e.g., on the screen 60, capturing a photograph or the like of the certified person of the identification card 20 by the camera 44).

Similarly to the screen 60, a screen 130 includes the certificate image 30. In addition, an image generated by the camera 44 is displayed in real time in a display area 134 of the screen 130. While checking a user's own appearance displayed in the display area 134, the user 10 performs an action (an action of facing up, down, left, or right, an action of tilting a face to left or right, an action of shutting a left or right eye, making a smile, opening a mouth, or the like) for instructed biometric detection.

The application 100 performs biometric detection by using an image captured by the camera 44 while the screen 130 is being displayed. Specifically, the application 100 determines whether a state of the user 10 is in a predetermined state (a state instructing to the user 10) for each image captured by the camera 44 after the screen 130 is output. When an image in which a state of the user 10 is in a predetermined state is detected, the biometric detection is successful. Note that, an existing technique can be used as a technique for analyzing an image including a person and thereby determining whether a state of the person is in a predetermined state.

When an image in which a state of the user 10 is in a predetermined state is not detected, the biometric detection fails. For example, the application 100 continues to display the screen 130 until the biometric detection succeeds. However, it is also possible to set a limitation on a time for continuing to display the screen 130, and to output an error message to the display apparatus 42 by the application 100 when the biometric detection does not succeed even after the limitation time has elapsed.

Note that, the above-described determination of the biometric detection may be performed by the server machine 80 instead of the application 100. In this case, the application 100 transmits each image generated by the camera 44 to the server machine 80. The server machine 80 transmits a notification indicating success or failure of the biometric detection to the application 100.

Herein, in order to perform biometric detection with high accuracy, it is preferable to cause the user 10 to perform a plurality of types of actions. In this case, the application 100 sequentially displays the screen 130 for each of a plurality of types of actions on the display apparatus 42, and performs detection of each type of action.

### <<Confirmation a Thickness of the Identification Card 20: S210>>

When the biometric detection succeeds, confirmation of a thickness of the identification card 20 is performed (S210). This is performed to confirm that the user 10 has an original of the identification card 20. Only receiving a provided image of the identification card 20 does not eliminate a possibility that, for example, the user 10 acquires a copy of the identification card 20 of another person and captures an image of the copy with the camera 44. Therefore, in order to confirm that the user 10 has an original of the identification card 20, not only a face of the identification card 20 but also the identification card 20 is captured from various angles to confirm that the identification card 20 has a thickness.

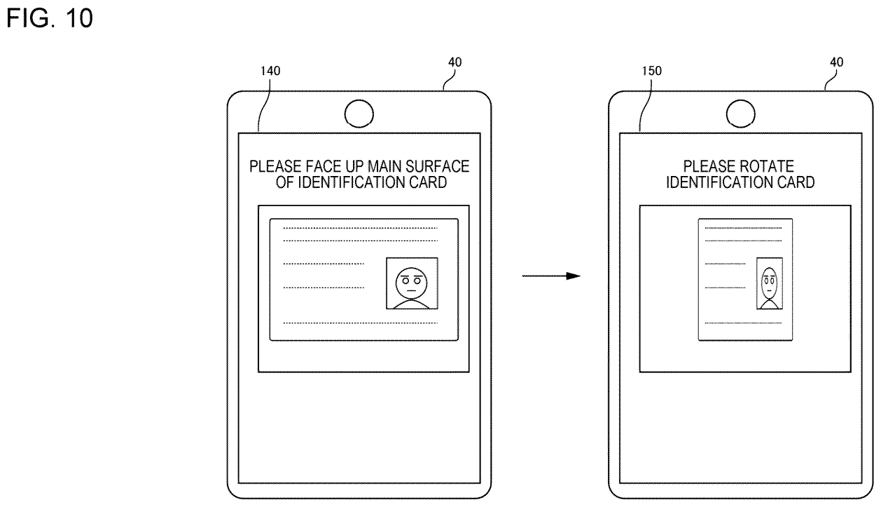

FIG. 10 is a diagram illustrating a screen for performing confirmation of a thickness of the identification card 20. In a screen 140, the user 10 causes the camera 44 to capture an image of the main surface of the identification card 20. The application 100 analyzes the image generated by the camera 44, and detects that the main surface of the identification card 20 has been captured. At this time, it is preferable that the application 100 confirms that the acquired image of the main surface of the identification card 20 matches the certificate image 30. For example, the confirmation is performed by confirming whether a person image included in an image of the identification card 20 acquired in a state where the screen 140 is displayed matches a person image included in the certificate image 30 acquired in S202.

Thereafter, the application 100 outputs a screen 150, and causes the user 10 to capture an image of the identification card 20 while rotating the identification card 20. The application 100 analyzes a plurality of images captured while rotating the identification card 20, and thereby confirms that the identification card 20 has a thickness. For example, the application 100 detects an image in which the identification card 20 is captured in each of a plurality of predetermined states (e.g., an image in which the main surface of the identification card 20 is captured from an angle of obliquely 45 degrees, an image in which the identification card 20 is captured from a right side, an image in which the back surface of the identification card 20 is captured from an angle of obliquely 45 degrees, and the like). When an image of the identification card 20 captured in each of a plurality of predetermined states is detected, the application 100 determines that confirmation of a thickness of the identification card 20 has succeeded. As a result, a series of pieces of processing for personal identification is completed.

While example embodiments of the present invention have been described above with reference to the drawings, these are examples of the present invention, and combinations of the above-described example embodiments or various configurations other than the above may be adopted.

Some or all of the above example embodiments may also be described as the following supplementary notes, but are not limited to the following.

1. A control apparatus including:
a first acquisition unit that acquires a certificate image being an image of an identification card;
a screen data output unit that outputs screen data of a first screen including the certificate image; and
a second acquisition unit that acquires an image of a user being generated by capturing an image performed in a state where the first screen is displayed.

2. The control apparatus according to supplementary note 1, wherein
the image of the user is generated by a camera controllable by a user terminal to be used by the user in a state where the first screen is displayed on a display apparatus controllable by the user terminal.

3. The control apparatus according to supplementary note 1 or 2, wherein
a second screen for capturing an image of the identification card is displayed before the first screen, and
the first acquisition unit acquires the certificate image generated by capturing an image performed in a state where the second screen is displayed.

4. The control apparatus according to any one of supplementary notes 1 to 3, wherein
an image of a person is displayed on the identification card, and
the second acquisition unit determines whether a person included in the certificate image matches a person included in an image acquired by the second acquisition unit.

5. A control method to be executed by a computer, including:
a first acquisition step of acquiring a certificate image being an image of an identification card;
a screen data output step of outputting screen data of a first screen including the certificate image; and
a second acquisition step of acquiring an image of a user being generated by capturing an image performed in a state where the first screen is displayed.

6. The control method according to supplementary note 5, wherein
the image of the user is generated by a camera controllable by a user terminal to be used by the user in a state where the first screen is displayed on a display apparatus controllable by the user terminal.

7. The control method according to supplementary note 5 or 6, wherein
a second screen for capturing an image of the identification card is displayed before the first screen,
the control method further including,
in the first acquisition step, acquiring the certificate image generated by capturing an image performed in a state where the second screen displayed.

8. The control method according to any one of supplementary notes 5 to 7, wherein
an image of a person is displayed on the identification card,
the control method further including,
in the second acquisition step, determining whether a person included in the certificate image matches a person included in an image acquired in the second acquisition step.

9. A program causing a computer to execute the control method according to any one of supplementary notes 5 to 8.

This application is based upon and claims the benefit of priority from Japanese patent application No. 2019-230599, filed on Dec. 20, 2019, the disclosure of which is incorporated herein in its entirety by reference.

### REFERENCE SIGNS LIST

10 User
20 Identification card
30 Certificate image
40 User terminal
42 Display apparatus
44 Camera
50 User image
60 Screen
62 Image capturing button
64 Display area
70 Screen data
80 Server machine
100 Application
110 Screen
112 Image capturing button
114 Display area
120 Screen
130 Screen
134 Display area
140 Screen
150 Screen
1000 Computer
1020 Bus
1040 Processor
1060 Memory
1080 Storage device
1100 Input/output interface
1120 Network Interface
2000 Control apparatus
2020 First acquisition unit
2040 Screen data output unit
2060 Second acquisition unit

1. An image processing method comprising:
displaying, on a terminal, a first screen for causing capture of a front surface of a target object whose front surface and back surface have different items of information;
controlling a camera of the terminal to automatically acquire a first image as the image of the front surface, in a case where a first condition is satisfied after the first screen is displayed;
displaying, on the terminal, a second screen for causing capture of the back surface of the target object after capturing the first image;
controlling the camera of the terminal to automatically acquire a second image as the image of the back surface, in a case where a second condition is satisfied after the second screen is displayed;
displaying, on the terminal, at a predetermined size, at least one of the first image or the second image; and
in a case where accepting an operation by a button displayed on the terminal when at least one of the first image or the second image is displayed at the predetermined size, transmitting, from the terminal to a server, a request to execute determination based on the at least one of the first image and the second image;
wherein the button is controlled to be operable after at least one of the first image and the second image is displayed at the predetermined size.

2. The image processing method according to claim 1, further comprising
displaying a result regarding a process executed by the server in response to the request.

3. The image processing method according to claim 2, wherein the result is displayed in a case where the server transmits information regarding notification to the terminal.

4. The image processing method according to claim 1, further comprising:
displaying, on the terminal, at least one instruction prompting at least one action by a user of the terminal; and
confirming, by the camera, whether a state of the user corresponds to the at least one action prompted by the at least one instruction.

5. The image processing method according to claim 1, wherein the first condition includes conditions related to the appearance of the target object in an image currently captured by the camera.

6. The image processing method according to claim 1, further comprising
performing optical character recognition (OCR) processing on the first image and the second image.

7. An image processing apparatus comprising:
at least one memory storing instructions; and
at least one processer configured to execute the instructions to perform operations comprising:
displaying, on a terminal, a first screen for causing capture of a front surface of a target object whose front surface and back surface have different items of information;
controlling a camera of the terminal to automatically acquire a first image as the image of the front surface, in a case where a first condition is satisfied after the first screen is displayed;
displaying, on the terminal, a second screen for causing capture of the back surface of the target object after capturing the first image;
controlling the camera of the terminal to automatically acquire a second image as the image of the back surface, in a case where a second condition is satisfied after the second screen is displayed;
displaying, on the terminal, at a predetermined size, at least one of the first image or the second image; and
in a case where accepting an operation by a button displayed on the terminal when at least one of the first image or the second image is displayed at the predetermined size, transmitting, from the terminal to a server, a request to execute determination based on the at least one of the first image and the second image;
wherein the button is controlled to be operable after at least one of the first image and the second image is displayed at the predetermined size.

8. The image processing apparatus according to claim 7, wherein the operations further comprise
displaying a result regarding a process executed by the server in response to the request.

9. The image processing apparatus according to claim 8, wherein the result is displayed in a case where the server transmits information regarding notification to the terminal.

10. The image processing apparatus according to claim 7, wherein the operations further comprise:
displaying, on the terminal, at least one instruction prompting at least one action by a user of the terminal; and
confirming, by the camera, whether a state of the user corresponds to the at least one action prompted by the at least one instruction.

11. The image processing apparatus according to claim 7, wherein the first condition includes conditions related to the appearance of the target object in an image currently captured by the camera.

12. The image processing apparatus according to claim 7, wherein the operations further comprise
performing optical character recognition (OCR) processing on the first image and the second image.

13. A non-transitory computer-readable medium storing a program for causing a computer to perform operations comprising:
displaying, on a terminal, a first screen for causing capture of a front surface of a target object whose front surface and back surface have different items of information;
controlling a camera of the terminal to automatically acquire a first image as the image of the front surface, in a case where a first condition is satisfied after the first screen is displayed;
displaying, on the terminal, a second screen for causing capture of the back surface of the target object after capturing the first image;
controlling the camera of the terminal to automatically acquire a second image as the image of the back surface, in a case where a second condition is satisfied after the second screen is displayed;
displaying, on the terminal, at a predetermined size, at least one of the first image or the second image; and
in a case where accepting an operation by a button displayed on the terminal when at least one of the first image or the second image is displayed at the predetermined size, transmitting, from the terminal to a server, a request to execute determination based on the at least one of the first image and the second image;
wherein the button is controlled to be operable after at least one of the first image and the second image is displayed at the predetermined size.

14. The non-transitory computer-readable medium according to claim 13, wherein the operations further comprise
displaying a result regarding a process executed by the server in response to the request.

15. The non-transitory computer-readable medium according to claim 14, wherein the result is displayed in a case where the server transmits information regarding notification to the terminal.

16. The non-transitory computer-readable medium according to claim 13, wherein the operations further comprise:
displaying, on the terminal, at least one instruction prompting at least one action by a user of the terminal; and
confirming, by the camera, whether a state of the user corresponds to the at least one action prompted by the at least one instruction.

17. The non-transitory computer-readable medium according to claim 13, wherein the first condition includes conditions related to the appearance of the target object in an image currently captured by the camera.

18. The non-transitory computer-readable medium according to claim 13, wherein the operations further comprise
performing optical character recognition (OCR) processing on the first image and the second image.
